(19) United States
(12) Patent Application Publication
(10) Pub. No.: US 2022/0192337 A1
(43) Pub. Date: Jun. 23, 2022

(54) Gaming Console Transportation Case

(71) Applicants: Anthony Young, Detroit, MI (US); Barbara Young, Detroit, MI (US)

(72) Inventors: Anthony Young, Detroit, MI (US); Barbara Young, Detroit, MI (US)

(21) Appl. No.: 17/547,832

(22) Filed: Dec. 10, 2021

Related U.S. Application Data
(60) Provisional application No. 63/128,893, filed on Dec. 22, 2020.

(51) Int. Cl. A45C 13/02; A45C 11/00; A45C 13/10; A45C 13/00; A45C 13/26; A45C 5/14; A63F 13/98

(52) U.S. Cl. CPC A45C 13/02; A45C 11/00; A45C 13/103; A45C 13/005; A45C 2011/003; A45C 5/14; A63F 13/98; A45C 2013/025; A45C 2013/267; A45C 13/262

(57) ABSTRACT

The present invention relates to a gaming console transportation case. The case can be equipped with a high definition monitor and a plurality of power outlets and is configured to be carried like a briefcase or pulled like a wheeled case. The transportation case provides storage for a complete gaming environment and system while protecting console components during travelling and transportation. The case includes a base portion and a hinged lid wherein the lid is hingedly connected to the base portion allowing pivotal movement of the lid relative to the base. To protect gaming console and associated components, the base portion has a foam lining with compartments. The lid can include an integrated display screen for displaying game interface and is connected to the gaming console through a connecting cord.

### CROSS-REFERENCE TO RELATED APPLICATION

The present application claims priority to, and the benefit of, U.S. Provisional Application No. 63/128,893, which was filed on Dec. 22^{nd}, 2020 and is incorporated herein by reference in its entirety.

### FIELD OF THE INVENTION

The present invention relates generally to the field of transportation cases. More specifically, the present invention relates to a multifunctional gaming console and transportation case that allows the users to store gaming devices and protects the stored devices while traveling. The case comprises of a base having a foam interior with a plurality of different sized compartments for storing various gaming components, and a hinged lid that is fastened to the base through a fastening mechanism such as a zipper. The gaming console and transportation case is in the form of a carrying case configured to be carried like a briefcase or pulled like a wheeled case, that provides a complete gaming environment for the users to play games as and when required. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, game consoles are used by gamers and other users for entertainment. For fun and entertainment at home and at get-togethers, people enjoy playing games on and otherwise utilizing gaming consoles. People enjoy game consoles from companies such as Microsoft, Nintendo, Sony and the like. Game consoles are generally sold as a unit that includes the console, one or more game-playing devices or controllers, and various wires and cables that are needed to operate the game console. However, the unit is sold without a dedicated display screen, and is therefore adapted to work with conventional displays and TV monitors. A user needs to connect the game console to a television, monitor or other video device on which the game interface will be displayed.

Generally, users such as children, gamers and even adults like to play games when they go on vacation or are outside, or otherwise travelling. Such people carry gaming consoles in their normal carry bags which can damage their gaming console components. Also, the wires or the cords may get misplaced, and the users ultimately need a display device to play the game, which may not always be available.

Some users, especially gamers, like to play games on their personal console and display. During traveling, the display may not always be available, thereby causing the gamers to become upset and bored. Sometimes, when the display is available, the position of the display may not be convenient to the user. Even the quality of the display may not be as per the preferences of the user. Thus, there is a need for a dedicated gaming transportation case allowing users to securely carry the gaming components and that also provides a display device for providing a complete gaming environment to a user.

Therefore, there exists a long felt need in the art for a gaming console transportation case that allows the users to securely carry the gaming console and components and reduces the likelihood of damaging the video device and/or game console. There is also a long felt need in the art for a gaming console transportation case that can provide a dedicated display screen for gaming. Additionally, there is a long felt need in the art for a gaming console transportation case that can provide the required power to the gaming console, thereby allowing a user to play games at any location. There is a long felt need in the art for a gaming console transportation case that provides a complete gaming environment to a user and increases a user's enjoyment. Moreover, there is a long felt need in the art for a gaming console transportation case that allows a desirable viewing position of the display to a user. Finally, there is a long felt need in the art for a gaming console transportation case that provides a means to safely transport and use electronics like video game consoles.

The subject matter disclosed and claimed herein, in one embodiment thereof, comprises a gaming system transportation case that provides a complete gaming environment and system for the users while protecting console components during traveling and transportation. The case further comprises a base portion and a hinged lid wherein the lid is hingedly connected to the base portion allowing a pivot movement of the lid relative to the base. The base portion includes a foam lining with pockets or compartments to house gaming console components and controllers, and the lid has a display screen configured to display the game interface and is connected to the gaming console through a connecting cord. Additionally, the base has a telescopic handle on the exterior surface for conveniently carrying the case. Further, the base and the hinged lid are fastened through a zipper in a closed position and the hinged lid makes an angle up to 120 degrees relative to the base for convenient viewing of the display screen while playing the game.

In this manner, the gaming console transportation case of the present invention accomplishes all of the forgoing objectives, and provides a relatively safe, easy and convenient case to securely carry and use a gaming console during traveling. The gaming console transportation case of the present invention is also user friendly, as it reduces the likelihood of damaging a game console. A dedicated display device to display game interface is provided by the case allowing amateur players and gamers to play games at any time and at any location.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gaming system transportation case. The gaming system transportation case is configured to provide a user a complete gaming environment and system while protecting console components during travelling and transport. The case further comprises a base portion and a hinged lid wherein the lid is hingedly connected to the base portion, allowing a pivot movement of the lid relative to the base, the base portion having a foam lining with pockets or compartments to house gaming console components and controllers, and the lid has a display screen configured to display game interface and is connected to the gaming console through a connecting cord. The base has a telescopic handle on the exterior surface for conveniently carrying the case. Further, the base and the hinged lid are fastened through a zipper in closed position and the hinged lid makes an angle up to 120 degrees relative to the base for convenient viewing of the display screen while playing the game.

In a further embodiment of the present invention, a portable gaming system is disclosed. The portable gaming system is in the form of a carrying case configured to be carried like a briefcase or pulled like a wheeled case. The gaming system comprises: a case having a base and a lid; the base and the lid are hingedly-connected to each other along an edge allowing a pivot movement of the lid relative to the base; the base having a foam sheet with pockets to store gaming console components; a case to protect the components from debris and dust; and, the hinged lid having a High Definition (HD) monitor attached to an inner portion that is configured to display the game interface. The HD monitor can be attached to the gaming console through a USB cable and can be connected to a power supply through a power cord. The case further includes a plurality of 110V power outlets and USB charging slots to provide power to each component of the gaming system.

In a further embodiment of the present invention, a transportation case for carrying a gaming console and associated display device is disclosed. The transportation case includes a base and a lid pivotally attached to each other by a plurality of hinges. The lid and the base are fastened to each other through a zipper in a closed position and the lid is pivotally-hinged at an angle greater than ninety degrees relative to the base in an open position. The base has a console storage area disposed on an interior-facing side of the base and is configured to receive the game console components. The lid has a display monitor storage area disposed on an interior-facing side of the lid and is configured to receive the display monitor. The exterior surface of the transportation case can include wheels and a telescopic handle to easily pull it, similar to a wheeled luggage case.

In yet a further embodiment of the present invention, the base portion has a foam lining with internal compartments or pockets to receive and store game console components. The compartments are deep enough to securely store the components. All the game console components including the display are connected through wired mechanisms which are provided in the case of the present invention.

The gaming console case can be used by professional gamers and amateur users. The case provides a complete gaming system allowing a gamer to play the game at any location and protects the gaming console during travel. All the video and audio devices are provided by the case and any additional components can be easily stored in the case of the present invention.

In a further embodiment of the present invention, the portable gaming case allows for full and easy access to controllers and displays of the game console without hindering or damaging the game console, cabling or peripherals while connected during play. The case houses game controllers, games and the various wires and/or cables necessary to utilize the game console for playing games. The case of the present invention allows the gamer to play games at virtually any desired location, including another room within a specific location with or without an onsite configuration and/or setup required.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of gaming console transportation case of the present invention in accordance with the disclosed architecture;

FIG. 2 illustrates a perspective view of one potential embodiment of gaming console transportation case of the present invention in an open position in accordance with the disclosed architecture;

FIG. 3 illustrates a perspective view of one potential embodiment of gaming console transportation case of the present invention with stored components and game console in accordance with the disclosed architecture;

FIG. 4 illustrates a side perspective view of one potential embodiment of gaming console transportation case of the present invention in accordance with the disclosed architecture;

FIG. 5 illustrates a perspective view showing a gamer playing a game using gaming environment provided by one potential embodiment of gaming console transportation case of the present invention in accordance with the disclosed architecture; and

FIG. 6 illustrates a perspective view of a closed case of another potential embodiment of gaming console transportation case of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a gaming console transportation case that allows the users to securely carry the gaming console and components and reduces the likelihood of damaging the video device and/or game console. There is also a long felt need in the art for a gaming console transportation case that can provide a dedicated display screen for gaming. Additionally, there is a long felt need in the art for a gaming console transportation case that can provide required power to the gaming console, thereby allowing a user to play games at any location. There is a long felt need in the art for a gaming console transportation case that provides a complete gaming environment to a user and increases a user's enjoyment. Moreover, there is a long felt need in the art for a gaming console transportation case that allows a desirable viewing position of the display to a user. Finally, there is a long felt need in the art for a gaming console transportation case that provides means to safely transport and use electronics such as video game consoles.

The present invention, in one exemplary embodiment, includes a portable gaming system carrying case. The portable gaming system is in the form of a carrying case configured to be carried like a briefcase or pulled like a wheeled case. The gaming system comprises: a case having a base and a lid; the base and the lid are hingedly-connected to each other along an edge, thereby allowing a pivot movement of the lid relative to the base; the base having a foam sheet with pockets to store gaming console components; a case to protect the components from debris and dust; and, the hinged lid having a High Definition (HD) monitor attached to an inner portion that is configured to display the game interface. The HD monitor can be attached to the gaming console through a USB cable and can be connected to a power supply through a power cord. The case further includes a plurality of 110V power outlets and USB charging slots to provide power to each component of the gaming system.

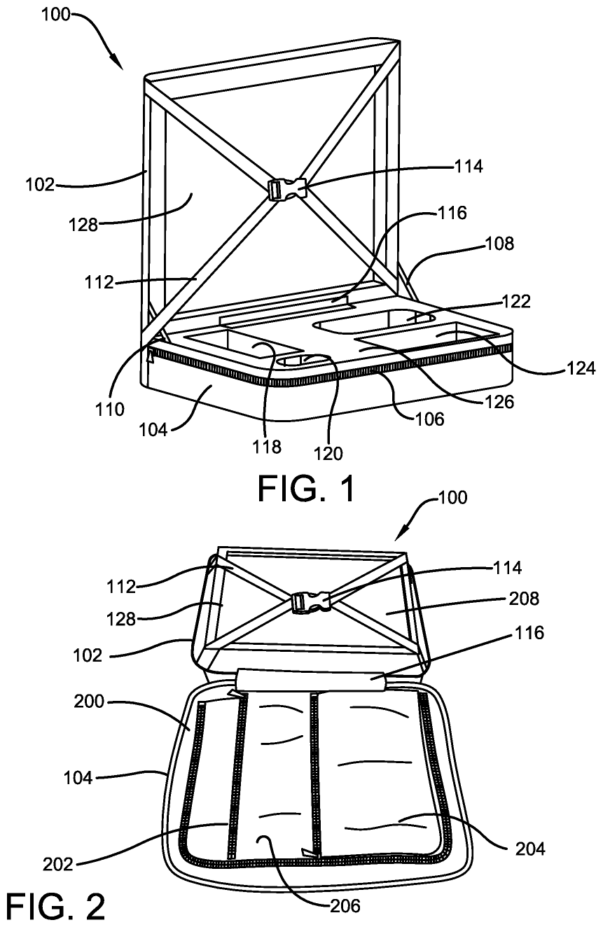

Referring initially to the drawings, FIG. 1 illustrates a perspective view of one potential embodiment of a gaming console transportation case of the present invention in accordance with the disclosed architecture. The gaming console transportation case 100 of the present invention is configured to securely store portable gaming consoles and other components. The case 100 allows game console players to carry a game console and its associated components and controllers easily, safely, and conveniently from one location to another. The case 100 can be used as a portable gaming system station allowing a gamer to play the game anywhere. The case 100 can be used for carrying components of any state-of-the-art gaming console such as an Xbox 360 Slim®, Play Station 3 Slim®, Xbox 360® or the like. The case 100 includes several power outlets and USB charging slots to provide power to each component and controller of the gaming console. To protect the console, the interior of the case 100 is lined with a soft and flexible material such as polyethylene foam. The foam material protects the game console components from incidental impacts during travel.

The gaming console transportation case 100 has a hinged lid 102 and a base portion 104. Both the hinged lid 102 and the base portion 104 are generally rectangular or square in shape. It should be noted that shape and size of the case 100 is dependent on the size and shape of the components and HD monitor. The base portion 104 houses the controllers and game console within a plurality of pockets 118, 120, 122, 124 carved into, or cut out from, the foam 126. The pockets 118, 120, 122, 124 are dimensioned as per the shape and size of various controllers and other components of a gaming console. The pocket 118 is designed to store 110V power outlets along with a plurality of USB charging slots.

The hinged lid 102 is hingedly-connected to the base portion 104 through a soft and flexible hinged portion 116. The hinged lid 102 houses an HD monitor 128. Preferably, the HD monitor 128 is a substantially flat liquid crystal display (LCD) or light-emitting diode (LED) screen, and may further comprise a plurality of screens. The HD monitor 128 can further include a pair of built-in stereo speakers. In case the HD monitor 128 does not have built-in speakers, the hinged lid 102 can support one or more portable speakers. A pair of straps 112 hooked through a snap hook 114 protects the HD monitor 128 and other audio components housed by the hinged lid 102. The housed HD monitor 128 allows users to use a personal video display device to play. The hinged lid 102 has a foam lining to protect the HD monitor 128 during travelling and from minor impacts resulting from same.

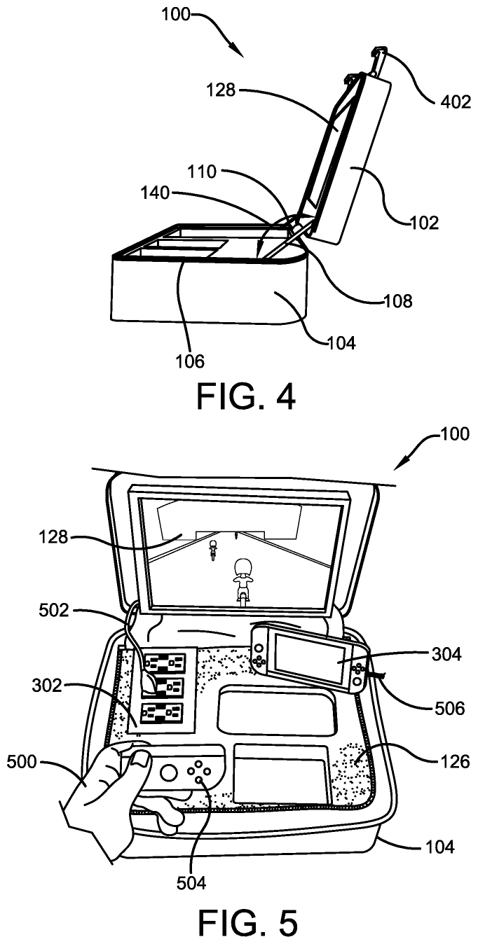

To allow the hinged lid 102 to be secured at a convenient viewing angle for a gamer, a pair of additional hinges 108, 110 can be present to support the lid 102. The hinges 108, 110 can be retention straps securable at a selectable length. The additional hinges 108, 110 function as locking tabs and allow the hinged lid 102 to be secured at various viewing angles. The viewing angle of the HD monitor 128 of the hinged lid 102 offers a convenient viewing angle during use. For example, the viewing angle can be generally from about 90 degrees to about 120 degrees measured as an angle 140 (FIG. 4) between the lid 102 and the base 104.

The exterior surface of the case 100 can be made up of a hard material such as plastic or a metal for protection against impacts and physical damage. In a closed position, the hinged portion 102 and the base portion 104 are fastened to each other using a fastener such as a zipper 106 present along the exterior surface of both the lower portion 104 and the hinged lid 102.

FIG. 2 illustrates a perspective view of one potential embodiment of the gaming console transportation case of the present invention in an open position in accordance with the disclosed architecture. The base 104 includes a cover 200 having a plurality of zipped compartments 202, 204, 206 to protect components of the gaming console. The cover 200 is zipped to an inner periphery of the base portion 102 to provide overall protection to the gaming components stored in the pockets of the foam (as described in FIG. 1). Each of the portions 202, 204, 206 of the zipped cover 200 can be unzipped to access the respective gaming console component stored in the pocket underneath the case. The cover 200 is flexible and waterproof. The cover 200 also protects the components from debris and dust. The hinged lid 102 includes the straps 112 to protect and secure the HD monitor 128. It should be noted that a plurality of wires or cords such as USB cables or charging cords are also stored in one or more pockets of the cover 200.

A plurality of straps may also be present to further support the components and controllers present in the base portion 104. The HD monitor 128 can be fixedly or removably mounted to the lid 102. A user can selectively remove the HD monitor 128 from the hinged lid 102 so that the user can replace, repair, or upgrade the HD monitor 128 as desired or necessary. The hinged lid 102 may have a casing in which the HD monitor 128 can be removably-attached. The lid 102 can include a screen cover 208 to protect the HD monitor 128 from scratches or other abrasions.

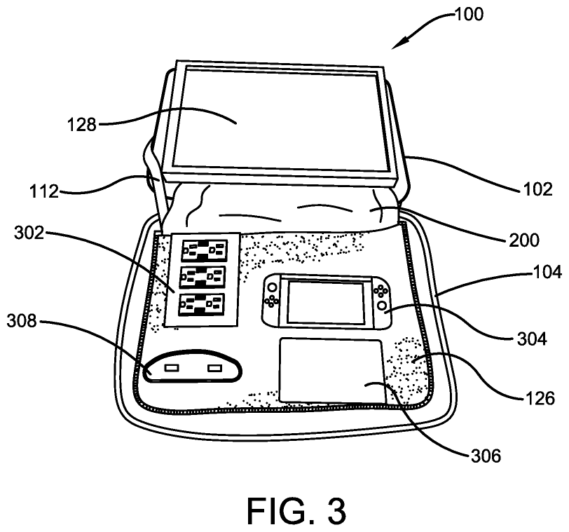

FIG. 3 illustrates a perspective view of one potential embodiment of the gaming console transportation case of the present invention with stored components and game console in accordance with the disclosed architecture. To access the gaming console 306 and the other components 304, 308 stored in the pockets of the foam 126, the cover 200 is unzipped and the components are accessed. A USB power supply and a plurality of 110V power outlets, comprising module 302, can be stored in one of the pockets of the base portion 104. Pockets to receive the gaming console components include a sufficient depth to easily and securely accommodate the game console 306, controller 304, power supply outlet 302 and USB chargers 308. Each component is surrounded by foam 126 to provide sufficient support for secure transport. The foam material 126 can also prevent overheating by enabling air circulation around the game console components. A user can easily access the game consoles and components, such as various controllers, cable ports and others from the base portion 104.

The HD monitor 128 can be accessed by unhooking the straps 112 of the lid 102. The hinged lid 102 can be positioned in a desired viewing position allowing a user to play a game comfortably. Additional hinged elements can be used to angle the lid 102 relative to the position of the base 104 in a desired orientation.

FIG. 4 illustrates a side perspective view of one potential embodiment of the gaming console transportation case of the present invention in accordance with the disclosed architecture. The hinged lid 102 can be securely set to a desired viewable position 140 using the hinges 108, 110 and the lid 102 can, in turn, be set to various viewing angles. The HD monitor 128 can be easily viewed by a user playing the game using the game console. A USB cable from the game console connects to the HD monitor 128 for displaying the real-time game. It should be appreciated that the monitor 128 can be used for viewing movies and other videos. The base 104 can be used to store different types of electronic, video and gaming consoles. In the present embodiment, a locking fastener 402 can be used to lock the hinged lid 102 to the base 104. A zipper 106 is also used for fastening the hinged lid 102 to the base 104.

The portable gaming system 100 provides a gamer with a complete gaming environment or gaming station, thereby allowing game playing at any location. The gaming console case 100 is useful for gaming competitions where each gamer attends and transports personal components in a case 100 including individual display monitors and gaming consoles. The gaming console case 100 is lightweight, sturdy, durable and comes in various colors, sizes and designs.

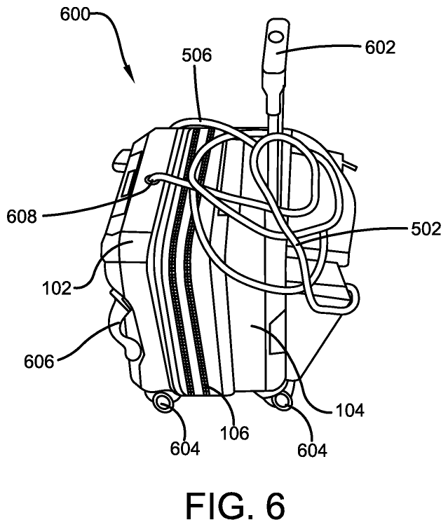

FIG. 5 illustrates a perspective view showing a gamer playing a game using the gaming environment provided by one potential embodiment of the gaming console transportation case of the present invention in accordance with the disclosed architecture. To play a game, required connections of the components of the gaming console are made. In one potential embodiment, power cords 502 of the case 100 are used for providing the required power. The power outlet 110V can provide the required power. The power can be provided by an external power supply. Alternatively, the power can be provided by a built-in battery. A USB cable can be connected to a USB port of the HD monitor 128 for making a connection with the gaming console. In one embodiment of the present invention, multiple monitors 128 may be included.

A gamer 500 can use one or more controllers 304, 504 for playing the game. The controllers can be wireless or wired. The wired controller 304 can be connected through one or more connecting cords 506. The components can be easily taken from the foam 126 for use and can be easily stored again. The HD monitor 128 can have a variety of ports such as an USB port, a HDMI port or any other port.

FIG. 6 illustrates a perspective view of a closed case of another potential embodiment of the gaming console transportation case of the present invention in accordance with the disclosed architecture. A game console case 600 can include a variety of handles 602, 606 and two pairs of wheels 604 to improve the transportability thereof. The two pairs of wheels 604 provide a stable base to stand up the case 600 in a vertical orientation. The game console case 600 can be carried like a briefcase or pulled like a wheeled case. For example, the case 600 includes a fixed handle 606 disposed on the hinged lid 102. A telescopic handle 602 can be used for pulling the case 600 on a floor using at least one pair of wheels 604. The connecting wires, or power cords, 502, 506 can be stored within the base portion 104, or can be carried around the telescopic handle 602. An opening 608 is present through the lid 102 from which one or more wires can be accessed (i.e. passed therethrough) and can be used for connecting to a power outlet.

As stated earlier, the base 104 and the hinged lid 102 are securely fastened to each other using a zipper fastener 106. Any other type of mechanical fastener can be used for fastening the base 104 and the lid 102 thereto, and for enabling secure transport of the game console case 100.

The gaming console case 100, 600 of the present invention provides a new lightweight carrying device for gamers to securely carry console components and a monitor, which is compatible with a low cost of manufacture with regard to both materials and labor, and accordingly is then compatible with low prices of sale to the consuming public, thereby making such game console case 100, 600 economically available to the buying public.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gaming console transportation case”, “gaming console case”, “case”, and “portable gaming system” are interchangeable and refer to the gaming console transportation case 100, 600 of the present invention.

Notwithstanding the forgoing, the gaming console transportation case 100, 600 of the present invention can be of any suitable size and configuration as is known in the art without affecting the overall concept of the invention, provided that it accomplishes the above-stated objectives. One of ordinary skill in the art will appreciate that the size, configuration and material of the gaming console transportation case 100, 600 as shown in the FIGS. are for illustrative purposes only, and that many other sizes and shapes of the gaming console transportation case 100, 600 are well within the scope of the present disclosure. Although the dimensions of the gaming console transportation case 100, 600 are important design parameters for user convenience, the gaming console transportation case 100, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A storage device configured to provide partitioned storage of a plurality of electronic game components, the storage device comprising:
a storage base including a plurality of individual compartments for holding the plurality of electronic game components, wherein said plurality of individual compartments include foam linings;
a storage lid including a compartment for holding a monitor, wherein said storage lid further comprises a strap for retaining the monitor in said compartment;
a zipper fastener for securing said storage base to said storage lid;
at least a first hinge for hingedly connecting said storage base to said storage lid; and
at least a second hinge for holding said storage lid at an angle relative to said storage base, wherein said angle is generally from about 90 degrees to about 120 degrees.

2. The storage device of claim 1 further comprising a cover for closing said plurality of individual compartments in said storage base.

3. The storage device of claim 2, wherein said storage base further comprises a telescoping handle and at least a first pair of wheels for pulling the storage device along a surface.

4. The storage device of claim 3 further comprising a second pair of wheels for standing said storage device in a vertical orientation.

5. The storage device of claim 4, wherein said monitor is selectively removable from said storage lid.

6. The storage device of claim 5, wherein said storage lid further comprises a protective screen cover for protecting said monitor.

7. The storage device of claim 6 further comprising a third hinge for holding said storage lid at an angle relative to said storage base, wherein said second hinge and said third hinge are retention straps for securing said storage lid at said angle relative to said storage base.

8. The storage device of claim 7, wherein said storage lid further comprises an opening for passing a power cord therethrough.

9. The storage device of claim 8, wherein said storage base further comprises a second handle for carrying said storage device.

10. A storage device configured to provide partitioned storage of a plurality of electronic game components, the storage device comprising:
a storage base including a plurality of individual compartments for holding the plurality of electronic game components, wherein said plurality of individual compartments include foam linings;
a storage lid including a compartment for holding a monitor, wherein said storage lid further comprises a strap for retaining the monitor in said compartment;
a zipper fastener for securing said storage base to said storage lid;
a first hinge for hingedly connecting said storage base to said storage lid;
a second hinge for holding said storage lid at an angle relative to said storage base, wherein said angle is generally from about 90 degrees to about 120 degrees;
said monitor is selectively removable from said storage lid; and
said storage lid further comprises a protective screen cover for protecting said monitor.

11. The storage device of claim 10 further comprising a cover for closing said plurality of individual compartments in said storage base.

12. The storage device of claim 11, wherein said storage base further comprises a telescoping handle and a first pair of wheels for pulling the storage device along a surface.

13. The storage device of claim 12 further comprising a second pair of wheels for standing said storage device in a vertical orientation.

14. The storage device of claim 13 further comprising a third hinge for holding said storage lid at an angle relative to said storage base, wherein said second hinge and said third hinge are retention straps for securing said storage lid at said angle relative to said storage base.

15. The storage device of claim 14, wherein said storage lid further comprises an opening for passing a power cord therethrough.

16. The storage device of claim 15, wherein said storage base further comprises a second handle for carrying said storage device.

17. A storage device configured to provide partitioned storage of a plurality of electronic game components, the storage device comprising:
a storage base including a plurality of individual compartments for holding the plurality of electronic game components;
a storage lid including a compartment for holding a monitor;
said storage lid further including a strap for retaining the monitor in said compartment;
said plurality of individual compartments include foam linings;
a zipper fastener for securing said storage base to said storage lid;
at least a first hinge for hingedly connecting said storage base to said storage lid;
at least a second hinge for holding said storage lid at an angle relative to said storage base;
a third hinge for holding said storage lid at an angle relative to said storage base;
said second hinge and said third hinge are retention straps for securing said storage lid at said angle relative to said storage base;
said angle is generally from about 90 degrees to about 120 degrees;
said monitor is selectively removable from said storage lid; and
said storage lid further includes a protective screen cover for protecting said monitor.

18. The storage device of claim 17 further comprising a cover for closing said plurality of individual compartments in said storage base.

19. The storage device of claim 18, wherein said storage base further comprises a telescoping handle and at least a first pair of wheels for pulling the storage device along a surface.

20. The storage device of claim 19, wherein said storage lid further comprises an opening for passing a power cord therethrough.
